(19) United States
(12) Patent Application Publication
(10) Pub. No.: US 2003/0128633 A1
(43) Pub. Date: Jul. 10, 2003

(54) Heat assisted magnetic recording head with hybrid write pole

(75) Inventors: Sharat Batra, Wexford, PA (US); Billy W. Crue, Pittsburgh, PA (US); William A. Challener, Sewickley, PA (US)

Correspondence Address: Benjamin T. Queen, II, Pietragallo, Bosick & Gordon, One Oxford Centre, 38th Floor, 301 Grant Street, Pittsburgh, PA, 15219, US

(73) Assignee: Seagate Technology LLC, Scotts Valley, CA

(21) Appl. No.: 10/157,219

(22) Filed: May 29, 2002

Related U.S. Application Data
(60) Provisional application No. 60/346,605, filed on Jan. 8, 2002.

(51) Int. Cl. G11B 11/00

(52) U.S. Cl. 369/13.32

(57) ABSTRACT

A magnetic recording head for use in conjunction with a magnetic recording medium. The magnetic recording head includes a hybrid write pole structure for applying a magnetic write field to the magnetic recording medium. The write pole includes a first layer and a second layer, wherein the first layer has a first saturation magnetic moment and the second layer has a second saturation magnetic moment that is greater than the first saturation magnetic moment. The magnetic recording head also includes a means for heating the magnetic recording medium proximate to where the write pole applies the magnetic write field to the recording medium. A method of heat assisted magnetic recording is also included.

### CROSS REFERENCE TO RELATED APPLICATION

This application claims the benefit of U.S. Provisional Application No. 60/346,605 filed Jan. 8, 2002.

### FIELD OF THE INVENTION

The invention relates to magnetic recording heads, and more particularly, to a heat assisted magnetic recording head with a hybrid write pole.

### BACKGROUND OF THE INVENTION

Magnetic recording heads have utility in a magnetic disc drive storage system. Most magnetic recording heads used in such systems today are “longitudinal” magnetic recording heads. Longitudinal magnetic recording in its conventional form has been projected to suffer from superparamagnetic instabilities at densities above approximately 40 Gbit/in². It is believed that reducing or changing the bit cell aspect ratio will extend this limit up to approximately 100 Gbit/in². However, for recording densities above 100 Gbit/in², different approaches will likely be necessary to overcome the limitations of longitudinal magnetic recording.

An alternative to longitudinal recording that overcomes at least some of the problems associated with the superparamagnetic effect is “perpendicular” magnetic recording. Perpendicular magnetic recording is believed to have the capability of extending recording densities well beyond the limits of longitudinal magnetic recording. Perpendicular magnetic recording heads for use with a perpendicular magnetic storage medium may include a pair of magnetically coupled poles, including a main write pole having a relatively small bottom surface area and a flux return pole having a larger bottom surface area. A coil having a plurality of turns is located adjacent to the main write pole for inducing a magnetic field between the pole and a soft underlayer of the storage media. The soft underlayer is located below the hard magnetic recording layer of the storage media and enhances the amplitude of the field produced by the main pole. This, in turn, allows the use of storage media with higher coercive force, consequently, more stable bits can be stored in the media. In the recording process, an electrical current in the coil energizes the main pole, which produces a magnetic field. The image of this field is produced in the soft underlayer to enhance the field strength produced in the magnetic media. The flux density that diverges from the tip into the soft underlayer returns through the return flux pole. The return pole is located sufficiently far apart from the main write pole such that the material of the return pole does not affect the magnetic flux of the main write pole, which is directed vertically into the hard layer and the soft underlayer of the storage media.

A magnetic recording system such as, for example, a perpendicular magnetic recording system may utilize a write pole having uniform magnetic properties, i.e. the write pole is formed of a single material having a uniform magnetic moment. However, such a write pole can exhibit skew effects which can degrade adjacent tracks.

Such magnetic recording systems alternatively may utilize a write pole having a “hybrid” design wherein, for example, a high saturation magnetic moment material is formed on top of or adjacent to a low saturation magnetic moment material. This type of design has been found effective in, for example, reducing skew effects during the writing process. Specifically, the hybrid pole design provides the advantages of generating a strong magnetic field due to the existence of a thick channel for the magnetic flux, formed by both the low moment material and high moment material, and the advantage of localizing a strong magnetic field in the region defined by the thickness of the high moment material at the write pole's trailing edge that is required for writing on a high coercive medium. The highly localized magnetic field from the write pole allows the use of a narrower trackwidth mainly because flux is efficiently channeled into a narrow trackwidth. The strong magnetic fields provided by this write pole structure permits the use of a magnetic recording media having a high anisotropy, thereby limiting superparamagnetic instabilities at high recording densities.

Another development that overcomes at least some of the problems associated with the superparamagnetic effect is heat assisted magnetic recording, sometimes referred to as optical or thermal assisted recording. Heat assisted magnetic recording generally refers to the concept of locally heating a recording medium to reduce the coercivity of the recording medium so that the applied magnetic writing field can more easily direct the magnetization of the recording medium during the temporary magnetic softening of the recording medium caused by the heat source. The heat assisted magnetic recording allows for the use of small grain media, which is desirable for recording at increased areal densities, with a larger magnetic anisotropy at room temperature and assuring a sufficient thermal stability.

More specifically, superparamagnetic instabilities become an issue as the grain volume is reduced in order to control media noise for high areal density recording. The superparamagnetic effect is most evident when the grain volume V is sufficiently small that the inequality KᵤV/k_{B}T>40 can no longer be maintained. Kᵤ is the material's magnetic crystalline anisotropy energy density, k_{B} is Boltzmann's constant, and T is absolute temperature. When this inequality is not satisfied, thermal energy demagnetizes the individual grains and the stored data bits will not be stable. Therefore, as the grain size is decreased in order to increase the areal density, a threshold is reached for a given material Kᵤ and temperature T such that stable data storage is no longer feasible.

The thermal stability can be improved by employing a recording medium formed of a material with a very high Kᵤ. However, with the available materials the recording heads are not able to provide a sufficient or high enough magnetic writing field to write on such a medium. Accordingly, it has been proposed to overcome the recording head field limitations by employing thermal energy to heat a local area on the recording medium before or at about the time of applying the magnetic write field to the medium. By heating the medium, the Kᵤ or the coercivity is reduced such that the magnetic write field is sufficient to write to the medium. Once the medium cools to ambient temperature, the medium has a sufficiently high value of coercivity and assures thermal stability of the recorded information. When applying a heat or light source to the medium, it is desirable to confine the heat or light to the track where writing is taking place and to generate the write field in close proximity to where the medium is heated to accomplish high areal density recording. The separation between the heated spot and the write field spot should be minimal or as small as possible so that the writing may occur while the medium temperature is substantially above ambient temperature. This also provides for the efficient cooling of the medium once the writing is completed.

Accordingly, there is identified a need for an improved magnetic recording head that overcomes limitations, disadvantages, and/or shortcomings of known magnetic recording heads. In addition, there is identified a need for an improved heat assisted magnetic recording head that overcomes limitations, disadvantages, and/or shortcomings of known heat assisted magnetic recording heads.

### SUMMARY OF THE INVENTION

Embodiments of the invention meet the identified needs, as well as other needs, as will be more fully understood following a review of the specification and drawings.

In accordance with an aspect of the invention, a magnetic recording head for use in conjunction with a magnetic recording medium comprises a write pole for applying a magnetic write field to the magnetic recording medium and means for heating the magnetic recording medium proximate to where the write pole applies the write field to the magnetic recording medium. The write pole includes a first layer and a second layer, wherein the first layer has a first saturation magnetic moment and the second layer has a second saturation magnetic moment that is greater than the first saturation magnetic moment.

In accordance with an additional aspect of the invention, a magnetic disc drive storage system comprises a magnetic recording medium and a magnetic recording head positioned adjacent to the magnetic recording medium. The magnetic recording head comprises a write pole for applying a magnetic write field to the magnetic recording medium and means for heating the magnetic recording medium proximate to where the write pole applies the write field to the magnetic recording medium. The write pole includes a first layer and a second layer, wherein the first layer has a first saturation magnetic moment and the second layer has a second saturation magnetic moment that is greater than the first saturation magnetic moment. The magnetic recording head may be a perpendicular magnetic recording head and the magnetic recording medium may be a perpendicular magnetic recording medium.

In accordance with another aspect of the invention, a method of heat assisted magnetic recording comprises applying heat to a magnetic recording medium and applying a magnetic write field to the heated portion of the magnetic recording medium using a write pole having a first layer and a second layer. The first layer has a first saturation magnetic moment and the second layer has a second saturation magnetic moment that is greater than the first saturation magnetic moment.

### BRIEF DESCRIPTION OF THE DRAWINGS

FIG. 1 is a pictorial representation of a disc drive system that may utilize a magnetic recording head in accordance with the invention.

FIG. 2 is a partially schematic side view of a magnetic recording head and a magnetic recording medium in accordance with the invention.

FIG. 3 is a graphical illustration of magnetic write field profiles for a hybrid write pole structure constructed in accordance with the invention and a write pole having a single or uniform material.

### DETAILED DESCRIPTION OF THE INVENTION

The invention provides a magnetic recording head, and more particularly a heat assisted magnetic recording head with a hybrid write pole. The invention is particularly suitable for use with a magnetic disc drive storage system. A recording head, as used herein, is generally defined as a head capable of performing read and/or write operations. Perpendicular magnetic recording, as used herein, generally refers to orienting magnetic domains within a magnetic storage medium substantially perpendicular to the direction of travel of the recording head and/or recording medium.

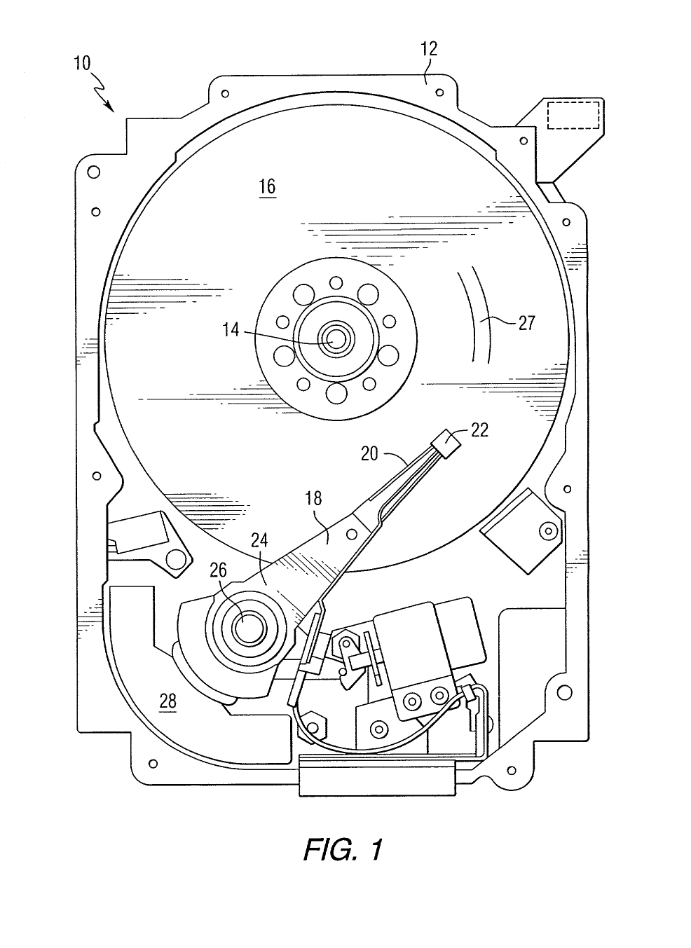

FIG. 1 is a pictorial representation of a disc drive 10 that can utilize a magnetic recording head, which may be a perpendicular magnetic recording head, constructed in accordance with this invention. The disc drive 10 includes a housing 12 (with the upper portion removed and the lower portion visible in this view) sized and configured to contain the various components of the disc drive. The disc drive 10 includes a spindle motor 14 for rotating at least one magnetic storage medium 16, which may be a perpendicular magnetic recording medium, within the housing. At least one arm 18 is contained within the housing 12, with each arm 18 having a first end 20 with a recording head or slider 22, and a second end 24 pivotally mounted on a shaft by a bearing 26. An actuator motor 28 is located at the arm's second end 24 for pivoting the arm 18 to position the recording head 22 over a desired sector or track 27 of the disc 16. The actuator motor 28 is regulated by a controller, which is not shown in this view and is well known in the art.

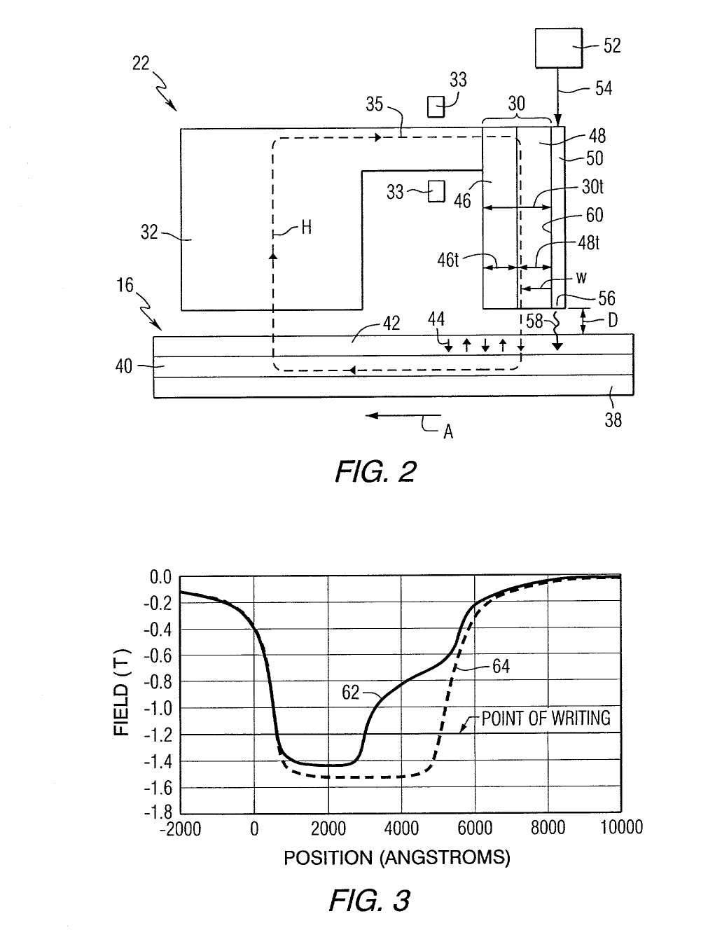

FIG. 2 is a partially schematic side view of a perpendicular magnetic recording head 22 and a perpendicular recording magnetic medium 16. Although an embodiment of the invention is described herein with reference to a perpendicular magnetic recording head, it will be appreciated that aspects of the invention may also be used in conjunction with other type recording heads where it may be desirable to employ heat assisted magnetic recording. Specifically, the recording head 22 may include a writer section comprising a main write pole 30 and a return or opposing pole 32 that are magnetically coupled by a yoke or pedestal 35. It will be appreciated that the recording head 22 may be constructed with a write pole 30 only and no return pole 32 or yoke 35. A magnetization coil 33 surrounds the yoke or pedestal 35 for energizing the recording head 22. The recording head 22 also may include a read head, not shown, which may be any conventional type read head as is generally known in the art.

Still referring to FIG. 2, the perpendicular magnetic recording medium 16 is positioned adjacent to or under the recording head 22 and travels in the direction of arrow A. The recording medium 16 includes a substrate 38, which may be made of any suitable material such as ceramic glass or amorphous glass. A soft magnetic underlayer 40 is deposited on the substrate 38. The soft magnetic underlayer 40 may be made of any suitable material such as, for example, alloys or multilayers having Co, Fe, Ni, Pd, Pt or Ru. A hard magnetic recording layer 42 is deposited on the soft underlayer 40, with the perpendicular oriented magnetic domains 44 contained in the hard layer 42. Suitable hard magnetic materials for the hard magnetic recording layer 42 may include at least one material selected from, for example, FePt or CoCrPt alloys having a relatively high anisotropy at ambient temperature.

In accordance with the invention, the main write pole 30 is a hybrid-type write pole structure. Specifically, the main write pole 30 includes a first layer 46 and a second layer 48. The second layer 48 may be formed directly adjacent to, in contact with, or on top of the first layer 46. The main write pole 30 may have a thickness 30t in the range of about 4000 angstroms (Å) to about 5000 Å. The first layer of material 46 may have a thickness 46t in the range of about 1000 Å to about 4000 Å. The second layer of material 48 may have a thickness 48t in the range of about 1000 Å to about 3000 Å.

It is desirable to have a main write pole 30 having a relatively high saturation magnetic moment (Mₛ), thereby resulting in a strong magnetic write field H. The strong magnetic write field H permits use of a magnetic storage medium 16 having a relatively high coercivity or anisotropy, thereby limiting superparamagnetic instabilities at high recording densities.

Referring to FIG. 2, the first layer 46 is a relatively low saturation magnetic moment material that provides the necessary flux efficiency to conduct the magnetic flux to the second layer 48. The second layer 48 is a relatively high saturation magnetic moment material that acts as the magnetic flux or magnetic field concentrating portion of the main write pole 30. Specifically, the first layer 46 is formed of a material having a saturation magnetic moment that may be, for example, less than about 1.0 Tesla (T). The first layer 46 may be generally referred to herein as a “low moment material” having a saturation magnetic moment generally within the range set forth herein. The second layer 48 is formed of a material having a saturation magnetic moment that is greater than the saturation magnetic moment of the first layer 46. For example, the second layer 48 may have a saturation magnetic moment that is greater than about 1.8 T. The second layer 48 may be generally referred to herein as a “high moment material” having a saturation magnetic moment generally within the range set forth herein.

The recording head 22 also includes means for heating the magnetic recording medium 16 proximate to where the write pole 30, and more specifically proximate to where the high moment material layer 48 applies the magnetic write field H to the recording medium 16. Specifically, the means for heating 50 may include, for example, an optical waveguide schematically represented by reference number 50. The optical waveguide 50 acts in association with a light source 52 which transmits light via an optical fiber 54 that is in optical communication with the optical waveguide 50. This provides for the generation of a surface plasmon or guided mode that may travel through the optical waveguide 50 toward a heat emission surface 56 that is formed along the air-bearing surface thereof. Heat or thermal energy, generally designated by reference number 58, is transmitted from the heat emission surface 56 of the optical waveguide 50 for heating a localized area of the recording medium 16, and particularly for heating a localized area of the recording layer 42.

The optical waveguide 50 may include a light transmissive material in optical communication with the light source 52 and optical fiber 54, as is generally known. The light transmissive material provides for the described generation of a surface plasmon or guided mode which propagate toward the medium 16. At the surface of the medium 16, the surface plasmon or guided mode can no longer propagate and a portion of its energy radiates light which in turn heats the medium 16. The light transmissive material may be formed, for example, from a silica based material, such as SiO₂, as is generally known. It will be appreciated that in addition to the light transmissive material, the waveguide 50 may include an optional cladding layer, such as aluminum, positioned adjacent the light transmissive material or an optional overcoat layer, such as an alumina oxide, for protecting the waveguide 50, as is generally known.

In addition to the optical waveguide 50, the means for heating the recording medium 16 may include other structures or devices for providing the necessary optical energy or thermal energy for heating the recording medium 16 and confining that energy to the recording spot. For example, the means for heating may include a waveguide, an antenna, a solid immersion lens, a waveguide mode index lens, or a surface plasmon lens.

The light source 52 may be, for example, a laser diode, or other suitable laser light sources.

To most effectively heat the recording medium 16, the heat emission surface 56 of the optical waveguide 50 may be spaced apart from the medium 16 and, more specifically, spaced apart from the recording layer 42, a distance D of about 5 nm to about 200 nm. It will be appreciated that the distance D is also dependent on the fly height required to maintain an acceptable signal-to-noise ratio (SNR) for the reader of the recording head 22.

The means for heating, and specifically the optical waveguide 50 or other structure, may be located adjacent to the second layer 48 of the write pole 30. More specifically, the optical waveguide 50 may be integrally formed with the write pole 30. Advantageously, these arrangements allow for heating of the recording medium 16 in close proximity to where the write pole 30, and specifically the second layer 48 thereof, applies the magnetic write field H to the recording medium 16. It also provides for the ability to align the waveguide 50 with the write pole 30 to maintain the heating application in the same track 27 of the medium 16 where the writing is taking place. Locating the optical waveguide 50 adjacent to the second layer 48 and/or integrally forming the optical waveguide 50 therewith, provides for increased writing efficiency due to the write field H being applied immediately downtrack from where the recording medium 16 has been heated. Advantageously, the use of the hybrid write pole 30 allows for optimum positioning of the optical waveguide 50 and the magnetic field H concentrating portion of the write pole, i.e., the second layer 48, relative to one another for heating and writing, in close proximity. The hot spot may ideally raise the temperature of the medium 16 to, for example, approximately 200° C. The recording takes place at the thermal contour in the medium 16 for which the coercivity is equal to the applied recording field. Ideally, this contour should be near the edge of the recording pole 30 where the magnetic field gradients are the largest. This will record the sharpest transition in the medium 16.

To further illustrate the benefit of the hybrid write pole 30, reference is made to FIG. 3. Specifically, FIG. 3 illustrates two magnetic field profiles versus the distance at which writing takes place from a trailing edge 60 (see FIG. 2) of the write pole 30. Line 62 represents the field profile for a hybrid write pole structure, such as write pole 30, wherein the first layer 46 has a thickness of 2000 Å and a saturation magnetic moment of 0.7T and the second layer 48 has a thickness of 3000 Å and a saturation magnetic moment of 2.0T. Line 64 represents the magnetic field profile for a write pole formed of a single or uniform material, i.e., a non-hybrid pole structure, wherein the write pole has a thickness of 5000 Å and the material of the write pole has a saturation magnetic moment of 2.0T. As illustrated in FIG. 3, the point of writing for the hybrid write pole 30 is approximately 2500 Å-3000 Å from the trailing edge 60 (this point of writing distance is illustrated as W in FIG. 2). In contrast, the point of writing for the single or uniform material write pole structure is approximately 5000 Å from a corresponding trailing edge thereof. Accordingly, it will be appreciated that the hybrid write pole 30 provides for the writing to take place at a location that is closer to the location in which the optical waveguide, or other means for heating that may be used, is positioned for heating the recording medium 16. This allows for the writing to take place while the temperature of the recording medium 16 is higher than the temperature at which writing would take place in a single or uniform material pole structure.

In operation, the recording medium 16 is passed under the recording head 22, in the direction indicated by arrow A. The light source 52 transmits light energy via the optical fiber 54 to the optical waveguide 50. The optical waveguide 50 transmits from the heat emission surface 56 thereof the optical or thermal energy for heating the recording medium 16. More specifically, a localized area of the recording layer 42 is heated to lower the coercivity thereof prior to the write pole 30 applying a magnetic write field H to the recording medium 16. Advantageously, this allows for a higher coercivity medium material to be used while limiting the superparamagnetic instabilities that may occur with such recording media used for high recording densities.

At a downtrack location from where the medium 16 is heated, the magnetic write pole 30 applies a magnetic write field to the medium 16 for storing magnetic data in the recording medium 16. The write field H is applied while the recording medium 16 remains at a sufficiently high temperature for lowering the coercivity of the recording medium 16. This insures that the write pole 30 and, specifically, the high moment second layer 48 thereof can provide a sufficient or high enough magnetic write field to perform a write operation on the recording medium 16. As described herein, the hybrid write pole 30 advantageously allows for the point of writing to be in close proximity to where the recording medium 16 is heated. Otherwise, the larger the distance between the point of writing and the point of heating results in a less efficient recording process due to the recording medium temperature having a longer time to cool prior to the write field H being applied to the medium 16.

Whereas particular embodiments have been described herein for the purpose of illustrating the invention and not for the purpose of limiting the same, it will be appreciated by those of ordinary skill in the art that numerous variations of the details, materials, and arrangement of parts may be made within the principle and scope of the invention without departing from the invention as described in the appended claims.

What is claimed is:

1. A magnetic recording head for use in conjunction with a magnetic recording medium, comprising:
a write pole for applying a magnetic write field to the magnetic recording medium, said write pole comprising a first layer and a second layer, said first layer having a first saturation magnetic moment and said second layer having a second saturation magnetic moment that is greater than said first saturation magnetic moment; and
means for heating the magnetic recording medium proximate to where said write pole applies said magnetic write field to the magnetic recording medium.

2. The magnetic recording head of claim 1, wherein said means for heating is located adjacent to said second layer of said write pole.

3. The magnetic recording head of claim 1, wherein said means for heating is integrally formed with said write pole.

4. The magnetic recording head of claim 1, wherein said means for heating includes an optical waveguide.

5. The magnetic recording head of claim 1, wherein said means for heating includes an optical antenna.

6. The magnetic recording head of claim 1, wherein said write pole is located down track from said means for heating.

7. The magnetic recording head of claim 1, wherein said first layer has a thickness in the range of about 1000 Å to about 4000 Å.

8. The magnetic recording head of claim 1, wherein said first saturation magnetic moment is less than about 1.0 T.

9. The magnetic recording head of claim 1, wherein said second layer has a thickness in the range of about 1000 Å to about 3000 Å.

10. The magnetic recording head of claim 1, wherein said second saturation magnetic moment is greater than about 1.8 T.

11. The magnetic recording head of claim 1, wherein said means for heating includes a heat emission surface located at an air-bearing surface thereof.

12. The magnetic recording head of claim 11, wherein said heat emission surface is spaced apart from the magnetic recording medium a distance of about 5 nm to about 200 nm.

13. The magnetic recording head of claim 1, wherein said second layer is the magnetic write field concentrating portion for applying the magnetic write field to the magnetic recording medium.

14. A magnetic disc drive storage system, comprising:
a magnetic recording medium; and
a magnetic recording head positioned adjacent to said magnetic recording medium, said magnetic recording head comprising:
a write pole for applying a magnetic write field to the magnetic recording medium, said write pole comprising a first layer and a second layer, said first layer having a first saturation magnetic moment and said second layer having a second saturation magnetic moment that is greater than said first saturation magnetic moment; and
means for heating the magnetic recording medium proximate to where said write pole applies said magnetic write field to the magnetic recording medium.

15. The system of claim 14, wherein said means for heating is located adjacent to said second layer of said write pole.

16. The system of claim 14, wherein said means for heating is integrally formed with said write pole.

17. The system of claim 14, wherein the magnetic recording head is a perpendicular magnetic recording head.

18. The system of claim 14, wherein the magnetic recording medium is a perpendicular magnetic recording medium.

19. A method of heat assisted magnetic recording, comprising:
applying heat to a magnetic recording medium; and
applying a magnetic write field to the heated portion of the magnetic recording medium using a write pole having a first layer and a second layer, wherein the first layer has a first saturation magnetic moment and the second layer has a second saturation magnetic moment that is greater than the first saturation magnetic moment.

20. The method of claim 19, further including positioning the second layer of the write pole adjacent to where the heat is applied to the magnetic recording medium.
